(19) United States
(12) Patent Application Publication
(10) Pub. No.: US 2003/0095712 A1
(43) Pub. Date: May 22, 2003

(54) Method for determining a data-compression method

(76) Inventors: Tilo Christ, Erlangen (DE); Heinz Prihoda, Heroldsberg (DE); Volker Schmidt, Erlangen (DE); Siegfried Schneider, Erlangen (DE); Hans-Dieter Schuell, Weisendorf (DE); Werner Striebel, Schwarzenbruck (DE); Gudrun Zahlmann, Neumarkt (DE)

Correspondence Address: SCHIFF HARDIN & WAITE, 6600 SEARS TOWER, 233 S WACKER DR, CHICAGO, IL, 60606-6473, US

(21) Appl. No.: 10/172,312

(22) Filed: Jun. 13, 2002

(30) Foreign Application Priority Data
Jun. 13, 2001 (DE) 101 28 532.9

(51) Int. Cl. G06K 9/36; G06K 9/00

(52) U.S. Cl. 382/232; 382/132

(57) ABSTRACT

In a method for determining a data-compression method from a set of data-compression methods for data compression of an image dataset allocated to an image, the image dataset is data-compressed at a first location, the data-compressed image dataset is transmitted via an information transmission network to a second location, and the data-compression methods from among the set of data-compression methods exhibit different compression factors, dependent on one or more criteria.

### BACKGROUND OF THE INVENTION

1. Field of the Invention

The present invention is directed to a method for determining a data-compression method with which an image dataset allocated to an image is data-compressed.

2. Description of the Prior Art

An image dataset allocated to a digitized image is generally relatively large, so that storing this dataset on, for example, a hard disk of a computer requires much memory space and the transmission thereof with an information transmission network such as, for example, the Internet or a telephone network exhibits a relatively long transmission time.

In order to save memory space or shorten the transmission time, the image dataset can be data-compressed by means of a suitable data-compression method. The data compression can ensue either loss-free in order to obtain a significantly smaller, data-compressed image dataset, or can ensue data-reduced. A data-reduced image dataset can, for example, be obtained by means of JPEG, whereby the degree of data compression or data reduction can be set by means of a compression factor. Particularly given a high compression factor, i.e. when the data-compressed image dataset is highly data-reduced compared to the original and non-compressed image dataset, the transmission time is in fact significantly shortened. The image allocated to the data-reduced image dataset, however, is usually qualitatively poorer than the image allocated to the original, non-reduced image dataset.

An image registered with an imaging medical-technical apparatus, for example, an x-ray device, particularly for diagnostic purposes, normally exhibits a high resolution, so that its image dataset is relatively large. An image dataset communicated via an information transmission network for diagnostic purposes must be transmitted optimally loss-free. In medical technology, the image dataset is therefore usually data-compressed loss-free according to the DICOM standard (Digital Imaging And Communication In Medicine). As described above, the transmission of an image dataset that has been data-compressed loss-free is relatively time-consuming compared to a data-compressed image dataset which is highly data-reduced.

### SUMMARY OF THE INVENTION

An object of the present invention is to provide a method that creates preconditions in order to determine a suitable data-compression method for data compression of an image dataset allocated to an image.

This object is achieved in accordance with the invention in a method for determining a data-compression method from a set of data-compression methods for data compression of an image dataset allocated to an image, wherein the image dataset is data-compressed at a first location, the data-compressed image dataset is transmitted via an information transmission network to a second location, and the data-compression methods of the set of data-compression methods exhibit different compression factors, and wherein the quality at the first location that the image to be transmitted to the second location is determined, on the basis of at least one criterion and based on the required quality, that data-compression method is selected for the set of data-compression methods that exhibits an optimally high compression factor and enables the required quality of the image to be transmitted.

Inventively, thus, data compression with a data-compression method is to be undertaken before the transmission of the image dataset. Data-compressed in this context means a loss-free data compression as well as a data-reduced data compression. A data-reduced image dataset is thus an image dataset that is data-compressed so as to be affected by losses. A criterion for the data compression or the data reduction is, moreover, the compression factor.

As already mentioned, a data-reduced image dataset can in fact be transmitted faster; the image allocated to the data-reduced image dataset, however, exhibits poorer image quality than the image allocated to the image dataset that has not been data-reduced. Inventively, therefore, the quality that the image should have at the second location, i.e. at the receiving location, is determined at the first location before the transmission. On the basis of the quality, a suitable data-compression method is subsequently determined at the first location, so that the image dataset is data-compressed (and also be data-reduced as needed), such that the data-compressed image dataset can be transmitted optimally fast and such that the image allocated to the data-compressed image dataset exhibits the desired quality.

Particularly in medical technology, images exhibit a high resolution, so that the image datasets allocated to these images are relatively large, and as a result long transmission times can arise. The inventive method therefore can be especially advantageously applied when, in an embodiment of the invention, the image was registered with an imaging medical-technical apparatus. The imaging medical-technical apparatus in one version of the invention can be a computer tomography apparatus, a magnetic resonance apparatus, an ultrasound device or an x-ray device.

In a preferred embodiment of the invention, the criterion is an employment of the image, or a legally allowed data compression of the image dataset allocated to the image, or the urgency of the transmission of the image dataset, or the bandwidth of the information transmission network, or technical equipment of a transmission device provided for sending the image dataset at the first location, or technical equipment of a reception device provided for reception of the image dataset at the second location, or the type of image dataset. If, for example, the image should exhibit optimally high quality at the receiving location, a data-compression method having a relatively low compression factor is, for example, employed. If the image dataset must be transmitted rapidly, for example, a data-compression method having a high compression factor can be employed. The compression factor, in contrast can be selected lower when the information transmission network has a large bandwidth, i.e. it can transmit data relatively fast. The technical equipment of the transmission device or reception device also determines which data-compression method can be employed. Legal factor must sometimes be taken into consideration in the selection of the data-compression method. Thus, for example, an image dataset that is allocated to an image that is to be employed for diagnosing a patient must be transmitted loss-free.

The type of image dataset in one version of the invention is determined by the imaging medical-technical apparatus.

In a preferred embodiment, the transmitted image dataset is employed for a medical finding, for a preview, for an archiving or for teaching purposes. As already indicated above, thus, the image dataset is compressed loss-free when the image allocated to the image dataset is to be employed for a medical finding. For a preview, in contrast, the transmitted image dataset can be highly data-compressed or data-reduced. Where the image is to be archived, it can likewise be relatively highly data-compressed or, respectively, data-reduced in order to save memory space. When, for example, the image is to be published in a textbook, the image should exhibit optimally high quality; the image dataset that is allocated to the image and transmitted therefore should be less highly data-compressed.

According to one version of the invention, the JPEG method, the wavelet method, the DICOM standard and/or the GIF method is employed as the data-compression method. The JPEG method, however, can be employed with various compression factors; JPEG having various compression factors are, moreover, viewed as being different data-compression methods in this context. Images can be transmitted loss-free with the GIF method and with the DICOM standard that is employed in medical technology.

Another advantage of the inventive method is that only data referred to as meta-data are required for the determination of the suitable data-compression method. Meta-data are data that describe the image dataset without the image allocated to the image dataset having to be known. As a result, it is also simpler for reasons relating to data regulations to offer the determination of the suitable data-compression method as a service.

### DESCRIPTION OF THE DRAWINGS

FIG. 1 illustrates a system suitable the inventive method.

FIGS. 2 through 4 are flow charts illustrating the inventive method.

### DESCRIPTION OF THE PREFERRED EMBODIMENTS

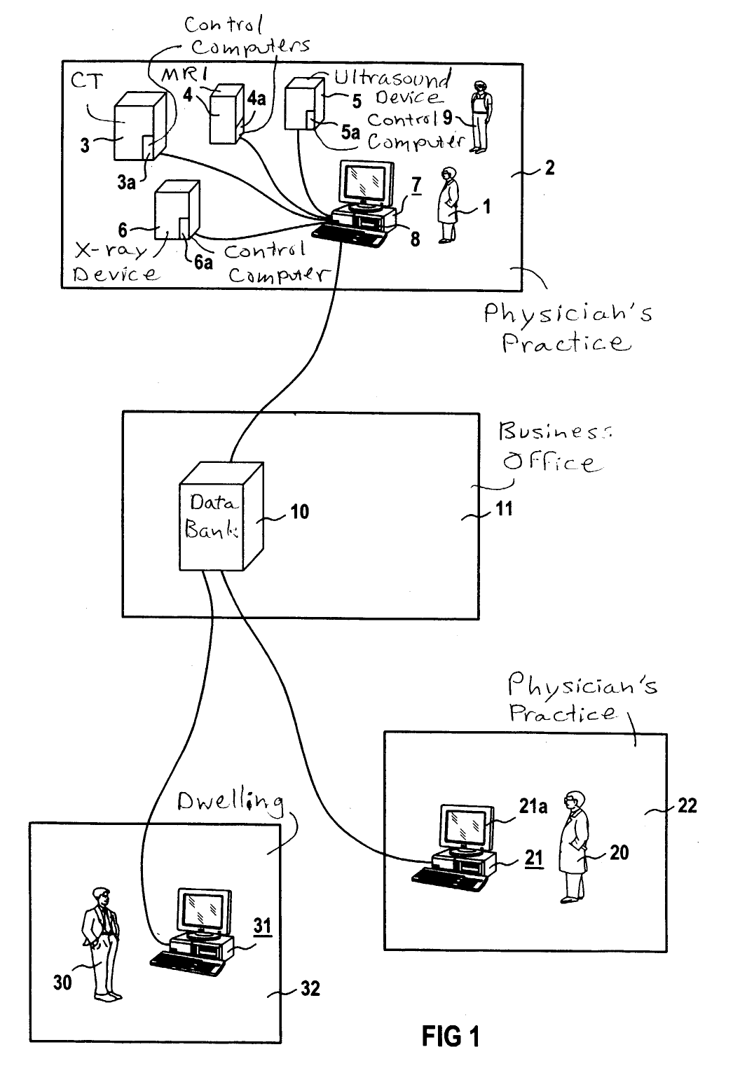

FIG. 1 shows a physician 1 in his practice 2 wherein, for example, a number of imaging medical-technical devices of the physician 1 are located. In the exemplary embodiment, the imaging medical-technical devices are a computed tomography system 3, a magnetic resonance apparatus 4, an ultrasound apparatus 5 and an x-ray device 6. The imaging medical-technical devices 3 through 6 respectively have a control computer 3a through 6a that are connected to a computer 7, so that image datasets that are allocated to images that were registered with the imaging medical-technical devices 3 through 6 can be stored in a memory 8 of the computer 7.

In the exemplary embodiment, the physician 1 produces an x-ray image (not shown in FIG. 1) with the x-ray device 6 of a patient 9 and stores the image dataset allocated to the x-ray image in the memory 8 of the computer 7. Further, the computer 7 is connected to the Internet, so that the physician 1 can communicate the image dataset allocated to the x-ray image to a databank 10 that is likewise connected to the Internet. In the exemplary embodiment, the physician 1 transmits the image dataset allocated to the x-ray image to the databank in uncompressed form, this databank 10 in the exemplary embodiment being located in the business office 11 of a telemedical service center and being likewise operated by the telemedical service vendor.

In the exemplary embodiment, the databank 10 also can be contacted by a further physician 20 with a computer 21 that is likewise connected to the Internet, this computer 21 being in the practice 22 of the physician 20. In the exemplary embodiment, the physician 1 would like to have the further physician 20 make a diagnosis of the patient 9 on the basis of the x-ray image produced by the physician 1. The physician 20 therefore contacts the databank 10 with the computer 21 in order to download an image dataset allocated to the x-ray image of the patient 9.

After the physician 20 has contacted the databank 10 with the computer 21 and has verified his access authorization, the physician must indicate the purpose for which he or she would like to employ the requested image dataset.

A suitable computer program is also stored in the databank 10, this computer program selecting a suitable data-compression method with which the image dataset stored in the databank 10 should be data-compressed before the transmission to the computer 21 based on the intended purpose of the requested image dataset, i.e. on the preparation of a diagnosis on the basis of the x-ray image prepared by the physician in the exemplary embodiment. What data-compression method the physician 20 can decipher with his or her computer 21 is also included in the computer program.

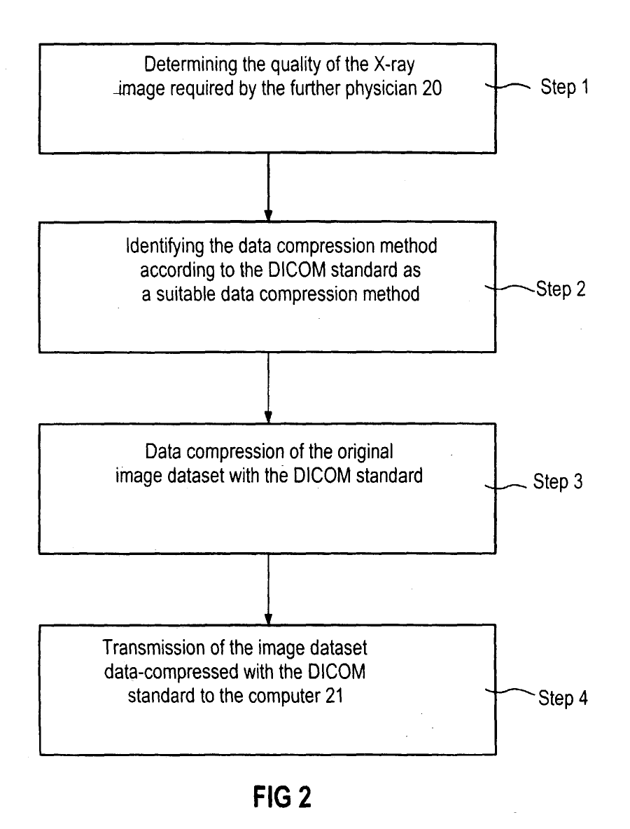

In the exemplary embodiment, the computer 21 executes a computer program with which image datasets according to the DICOM standard (digital imaging and communication in medicine) can be deciphered, this, moreover, enabling a loss-free data compression. As already discussed, the requested image dataset is to be employed for a diagnosis of the patient 9 and therefore must not be data-reduced for legal reasons in the exemplary embodiment. On the basis of this information, the computer program stored in the databank 10 determines that the further physician 20 requires a high-quality x-ray image (Step 1 of the flow chart shown in FIG. 2), for which reason the DICOM standard is suited for a data compression of the image dataset to be transmitted to the computer 21 (Step 2 in the flow chart illustrated in FIG. 2).

Subsequently, the computer program stored in the databank 10 data-compresses the image dataset allocated to the x-ray image according to the DICOM standard (Step 3 of the flow chart shown in FIG. 2) and communicates the data-compressed image dataset to the computer 21 of the further physician 20 (Step 4 of the flow chart shown in FIG. 2).

After the image dataset data-compressed according to the DICOM standard has been communicated to the computer 21, the further physician 20 views the x-ray image allocated to the communicated image dataset with a monitor 21a of the computer 21 and produces a diagnosis of the patient 9. Subsequently, the further physician 20 communicates a dataset allocated to the finding to the databank 10 with his computer 21. The computer program stored in the databank 10 subsequently links the dataset allocated to the finding with an image dataset allocated to the x-ray image to a further dataset, so that the diagnosis can be shown with the x-ray image. The further dataset is subsequently forwarded to the computer 7 of the physician 1, so that the physician 1 can read the diagnosis prepared by the further physician 20.

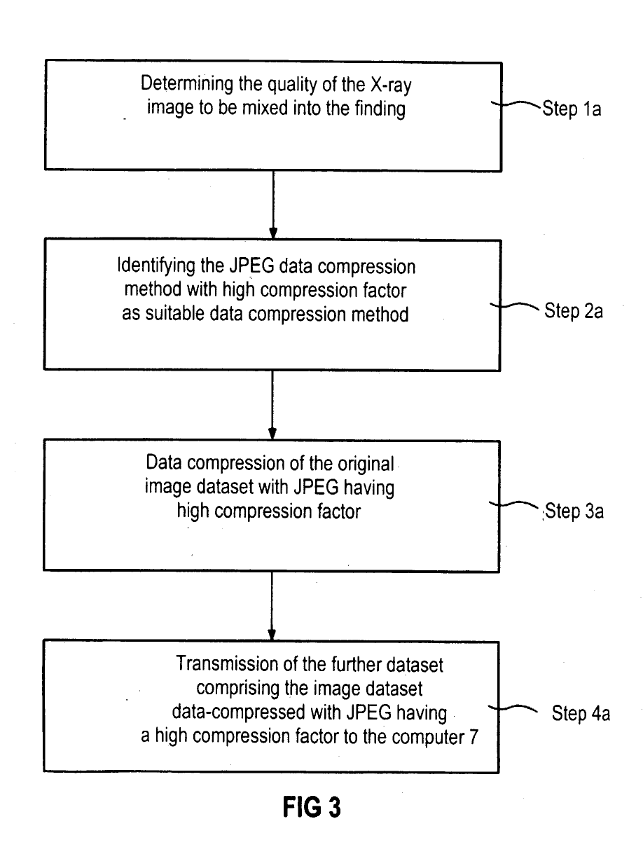

Before the further dataset is produced, the computer program stored in the databank 10 recognizes that the image dataset employed for the further dataset is allocated to an image that serves the purpose of illustrating the diagnosis. Since, moreover, the physician 1 has a loss-free image dataset of the x-ray image available to him or her, the x-ray image of the diagnosis need not be of especially high quality. A computer program with which a dataset data-compressed with JPEG can be deciphered also is stored in the computer 7. This information is likewise deposited in the computer program that is stored in the databank 10. The computer program stored in the databank 10 therefore determines that the x-ray image mixed into the diagnosis can be of a lower quality (Step 1a of the flow chart shown in FIG. 3) and that JPEG with a high compression factor is a suitable data-compression method (Step 2a of the flow chart shown in FIG. 3).

Subsequently, the image dataset employed for the further dataset is data-compressed or data-reduced with a high compression factor with the JPEG method before being linked to the dataset allocated to the finding, so that a fast transmission from the databank 10 to the computer 7 is enabled (Step 3a of the flow chart shown in FIG. 3).

Subsequently, the further dataset is communicated to the computer 7 of the physician 1 (Step 4a of the flow chart shown in FIG. 3).

In the exemplary embodiment, moreover, a medical student 30 can contact the databank 10 with a computer 31 from his residence 32 in order to download image datasets therefrom for training purposes. The computer 31 is likewise connected to the Internet and comprises a computer program that, in the present exemplary embodiment, can decipher image datasets according to the JPEG method.

In the exemplary embodiment, the medical student 30 wishes to prepare for an exam and check his or her ability to produce a diagnosis on the basis of an x-ray image. The student 30 therefore contacts the databank 10 in order to obtain the x-ray image of the patient 9.

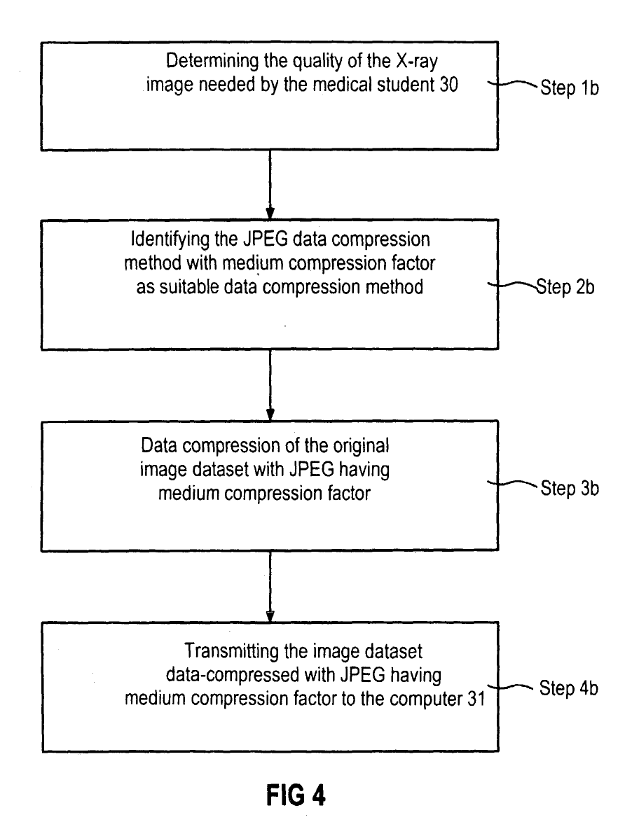

After the medical student 30 has contacted the databank 10 with the computer 31, has verified his or her identity and indicated that he or she wishes to employ the image dataset for preparing for the examination, the computer program stored in the databank 10 determines a required quality of the x-ray image. In the exemplary embodiment, the computer program uses this information to determine that the medical student 30 needs only an x-ray image of medium quality since the student 30 does not wish to produce a real diagnosis but needs the image dataset for training purposes (Step 1b of the flow chart illustrated in FIG. 4). Consequently, JPEG with a medium compression factor is an adequate data-compression method (Step 2b) of the flow chart shown in FIG. 4).

Subsequently, the computer program stored in the databank 10 data-compresses the original image dataset communicated from the physician 1 according to the JPEG method with a medium compression factor (Step 3b of the flow chart shown in FIG. 4) and communicates the data-compressed image dataset, which is also data-reduced in this case to the computer 31 (Step 4a of the flow chart shown in FIG. 4), so that the medical student 30 can view the x-ray image allocated to the communicated, data-compressed image dataset.

In the exemplary embodiment, the image datasets are allocated to an x-ray image. However, image datasets can also be employed that are allocated to images that were registered with the computer tomograph 3, the magnetic resonance apparatus 4 or the ultrasound apparatus 5. For the inventive method, however, other medical or even non-medical images can be employed.

Further are other data-compression methods other than the JPEG or methods working according to the DICOM standard described in the exemplary embodiment can be employed for the inventive method. The wavelet method is an example of such a further data-compression method.

The databank 10 need also not necessarily be operated by a telemedical service vendor. The physician 1, the further physician 20 and the medical student 30 are also only of an exemplary nature. Other persons can also request an image dataset from the databank 10.

Further, some other information transmission networks such as, for example, a telephone network can be employed for the transmission of the image datasets.

The criteria cited in the exemplary embodiment for determining a suitable data-compression method are also only examples. A number of criteria also need not be employed; one criterion for determining the required quality of the image to be communicated also suffices for the inventive method.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for determining a data-compression method from among a set of data-compression methods for data compression of an image dataset representing an image, comprising the steps of:
at a first location, determining a quality of an image, dependent on at least one criterion, which is necessary in order for said image to have a satisfactory quality at a second location, remote from said first location after transmission of an image dataset, representing said image, from said first location to said second location;
dependent on said quality at said first location, selecting a data-compression method, as a selected data-compression method, having a compression factor that enables said image to have said satisfactory quality at said second location, after transmission to said second location from said first location; and
data-compressing an image dataset representing said image at said first location to obtain a data-compressed image dataset using said selected data-compression method, transmitting said data-compressed image dataset from said first location to said second location.

2. A method as claimed in claim 1 comprising generating said image using a medical-technical imaging apparatus.

3. A method as claimed in claim 2 comprising selecting said medical-technical imaging apparatus from the group consisting of computed tomography systems, magnetic resonance apparatuses, ultrasound devices, and x-ray devices.

4. A method as claimed in claim 1 comprising selecting said at least one criterion from the group consisting of use of said image at said second location, legally permissible data compression of said image dataset, an urgency associated with transmission of said image dataset from said first location to said second location, a bandwidth of an information transmission network used to transmit said data-compressed image dataset from said first location to said second location, technical equipment of a transmission device at said first location used for transmitting said data-compressed image dataset to said second location, technical equipment of a reception device at said second location used to receive said data-compressed image dataset from said first location, and a type of said image dataset.

5. A method as claimed in claim 1 comprising generating said image dataset using a medical-technical imaging apparatus from among a group of different types of medical-technical imaging apparatuses, respectively producing image datasets of corresponding types, and further comprising employing the type of image dataset as said criterion.

6. A method as claimed in claim 1 comprising employing a use of said image dataset at said second location as said criterion, and selecting said use from the group consisting of making a medical finding, previewing said image, archiving said image, and educational use of said image.

7. A method as claimed in claim 1 comprising employing a set of data-compression methods including the JPEG method, the wavelet method, the DICOM standard and the GIF method as said set of data-compression methods from which said selected data-compression method is selected.

8. A method for determining a data-compression method comprising the steps of:
storing a first image dataset for an image in a databank;
receiving an inquiry that a second image dataset for said image is to be communicated to a reception device via an information transmission network;
determining an image quality that said image of said second image dataset should have dependent on at least one criterion;
selecting a data-compression method, from among a set of data-compression methods respectively having different compression factors, as a selected data-compression method, so that said second image dataset enables said image quality to be satisfied and so that the selected data-compression method exhibits a compression factor as high as possible;
producing said second image dataset using the selected data-compression method from said first image dataset; and
transmitting said second image dataset via said information transmission network to said reception device.

9. A method as claimed in claim 8 comprising generating said image using a medical-technical imaging apparatus.

10. A method as claimed in claim 9 comprising selecting said medical-technical imaging apparatus from the group consisting of computed tomography systems, magnetic resonance apparatuses, ultrasound devices, and x-ray devices.

11. A method as claimed in claim 8 comprising selecting said at least one criterion from the group consisting of use of said image at said second location, legally permissible data compression of said image dataset, an urgency associated with transmission of said image dataset from said first location to said second location, a bandwidth of an information transmission network used to transmit said data-compressed image dataset from said first location to said second location, technical equipment of a transmission device at said first location used for transmitting said data-compressed image dataset to said second location, technical equipment of a reception device at said second location used to receive said data-compressed image dataset from said first location, and a type of said image dataset.

12. A method as claimed in claim 8 comprising generating said image dataset using a medical-technical imaging apparatus from among a group of different types of medical-technical imaging apparatuses, respectively producing image datasets of corresponding types, and further comprising employing the type of image dataset as said criterion.

13. A method as claimed in claim 8 comprising employing a use of said image dataset at said second location as said criterion, and selecting said use from the group consisting of making a medical finding, previewing said image, archiving said image, and educational use of said image.

14. A method as claimed in claim 8 comprising employing a set of data-compression methods including the JPEG method, the wavelet method, the DICOM standard and the GIF method as said set of data-compression methods from which said selected data-compression method is selected.

15. A method as claimed in claim 8 comprising employing a computer connectable to said information transmission network as said reception device.
